(19) United States
(12) Patent Application Publication
(10) Pub. No.: US 2022/0196886 A1
(43) Pub. Date: Jun. 23, 2022

(54) METHOD FOR AVOIDING GRAVITY-INDUCED ROTATIONALLY NON-SYMMETRIC OPTICAL ERRORS IN PERMANENTLY INSTALLED (FIXED) MACHINE VISION AND CODE READING IMAGING SETUPS THAT ARE USING LIQUID LENS TECHNOLOGIES

(71) Applicant: Optotune AG, Dietikon (CH)

(72) Inventor: Michael Büeler, Vogelsang (CH)

(73) Assignee: Optotune AG, Dietikon (CH)

(21) Appl. No.: 17/555,456

(22) Filed: Dec. 19, 2021

(30) Foreign Application Priority Data
Dec. 21, 2020 (DE) 10 2020 134 508.9

(51) Int. Cl. G02B 3/14; G02B 5/06; G02B 26/08; G02B 27/00

(52) U.S. Cl. CPC G02B 3/14; G02B 27/0025; G02B 26/0891; G02B 5/06

(57) ABSTRACT

An optical device for machine vision, particularly for automatically extracting information from images of an object, comprising:
a first optical path, which is arranged to image a first object plane,
a second optical path, which is arranged to image a second object plane,
an image sensor which is arranged to capture the image of the first and/or second object plane, wherein
the first object plane extends obliquely with respect to the second object plane,
the first optical path and the second optical path extend through a first liquid lens with an optical axis, wherein
the optical axis extends vertically.

### FIELD

The present invention relates to an optical device for machine vision and a corresponding method.

### BACKGROUND

Liquid lenses are very versatile. They usually comprise a deformable membrane adjacent a transparent optical liquid. By deforming the membrane, the optical properties of the liquid lens such as its focal power can be precisely adjusted.

However, in case such liquid lenses are mounted with a horizontal optical axis, gravity causes the membrane to take a rotationally non-symmetric shape which produces an optical error known as gravity-induced coma.

One method to reduce this gravity-induced shape deformation is to use a stiffer membrane. A stiffer membrane however would require more motor force to achieve the same focal power range in the liquid lens, and more motor force means more heating of the lens which is undesired due to heat-induced changes of the optical properties of the lens materials.

A second method to minimize the gravity-induced shape deformation of the membrane consists of compensating the induced optical error by a fixed optical element that has to be mounted in the exact rotational alignment to the liquid lens. This solution however is rather expensive and would have a contrary i.e. deteriorating effect on the optical quality as soon as such a camera would be oriented with a vertical optical axis.

Furthermore, a passive adaptive gravity-coma compensation technology (e.g. WO2020/039047A1) has been recently proposed, which would overcome the downsides of the two previous potential solutions, but requires a rather complex manufacturing process.

### SUMMARY

Based on the above, the problem to be solved by the present invention is to provide an optical device and a method for that are improved regarding the above-stated disadvantage of gravity-induced optical errors.

An optical device for machine vision, particularly for automatically extracting information from images of an object, comprising:
a first optical path, which is arranged to image a first object plane,
a second optical path, which is arranged to image a second object plane,
an image sensor which is arranged to capture the image of the first and/or second object plane, wherein
the first object plane extends obliquely with respect to the second object plane,
the first optical path and the second optical path extend through a first liquid lens with an optical axis, wherein
the optical axis extends vertically.

In particular, the first optical path and the second optical path may be partially identical. For example, a semi-reflective element, a beam splitter, a movable prism or a movable mirror may be arranged in the first and/or second optical path, to superimpose sections of the first optical path and the second optical path.

The image sensor may comprise multiple sensor units, wherein one sensor unit is arranged to capture the image provided through the first optical path and a different sensor unit is arranged to capture the image provided through the second optical path.

In particular, the first object plane may extend vertically. Here and in the following vertical identifies a direction which extends in the direction of gravity. The first and second object plane may extend perpendicular with respect to each other.

The optical device can comprise an analyzing unit connected to the image sensor, the analyzing unit being configured to automatically extract an information from said at least one image (or from a series of images) about the object. The at least one first liquid lens (and the second liquid lens, see below) may comprise a container that is filled with the transparent liquid, wherein the membrane forms a deformable, particularly elastically deformable, transparent wall of this container. On a side opposing the membrane, the container can comprise a rigid transparent wall or a further membrane. The rigid transparent wall can form an optical element like a lens, but can also be a flat plate. The optical axis extends essentially perpendicular with respect to a surface of the membrane, when the membrane is in flat tuning state, and the optical axis extends through the transparent liquid and the rigid transparent wall or the further membrane.

Particularly, the present invention aims at utilizing the advantages of liquid lenses and avoiding—at the same time—any rotationally non-symmetric gravity-induced optical errors by always mounting the part of the optical device, which comprises the tunable liquid lense(s), with a vertical optical axis of the liquid lense(s). In an embodiment, this part of the device is also denoted as back part (see e.g. below).

For this, it is important that the one (back) part of the optical device that comprises all the liquid lenses is oriented in a vertical optical axis. Any rigid optical elements that might come in front of the liquid lens part might be oriented with a horizontal optical axis by means of a folding element such as a mirror or a prism if required.

According to one embodiment, the first optical path and the second optical path extend through a common first liquid lens, wherein the first liquid lens comprises a deformable transparent membrane and a transparent liquid arranged adjacent the membrane, wherein the optical device is configured to adjust the focal power of the first liquid lens by changing a curvature of said membrane The first optical path and the second optical path are partially superimposed, wherein the first tunable lens is arranged in the superimposed section.

According to one embodiment, the first optical path and the second optical path extend through different first liquid lenses, wherein the first liquid lenses respectively comprise a deformable transparent membrane and a transparent liquid arranged adjacent the membrane, wherein the optical device is configured to adjust the focal power of the first liquid lenses by changing a curvature of said membranes, and the optical axes of the first liquid lenses extend parallel to each other.

Particularly, according to an embodiment of the present invention, the first and the second optical path comprises a front part configured to receive light coming from the object and to pass light to a back part of the optical device, the back part comprising the at least one first liquid lens.

Furthermore, according to a preferred embodiment, the front part comprises a rigid objective lens for passing light, particularly deflecting light, coming from the object to the at least one first liquid lens, wherein particularly an optical axis of the rigid objective lens is aligned with the optical axis of the at least one first liquid lens. Particularly, this embodiment can be used for top-down or bottom-up imaging of the first object plane. Here, the first optical path features a straight non-folded design.

If a horizontal view of the optical device is required for imaging the second object plane, the front part of the optical device comprises a folding element according to an embodiment, the folding element being configured to redirect light coming from the object to the at least one liquid lens. In an embodiment, the folding element is a mirror or a prism.

Particularly, according to an embodiment, one or several further rigid optical elements, particularly one or several rigid lenses can be arranged in front of the folding element that is then arranged between the further optical element(s) and the at least one first liquid lens.

According to an alternative embodiment, the folding element can form a first optical element in the first or second optical path of the optical device extending from the folding element to the image sensor.

According to yet another embodiment of the optical device according to the present invention, the back part of the optical device comprises a second liquid lens arranged in the first and/or second optical path of the optical device between the at least one first liquid lens and the image sensor.

According to a further preferred embodiment of the present invention, the second liquid lens comprises an optical axis, the optical axis of the second liquid lens extending vertically in said operating mode. Particularly, the optical axes of the at least one first liquid lens and the second liquid lens coincide.

According to a preferred embodiment, the optical device comprises an optical zoom device, the optical zoom device comprising the at least one first liquid lens and the second liquid lens being arranged between the at least one first liquid lens and the image sensor. Particularly, the second liquid lens can be designed according to said at least one first liquid lens, i.e., comprise a transparent deformable membrane adjacent a transparent liquid, wherein the optical device is configured to adjust the focal power of the second liquid lens by changing a curvature of said membrane of the second liquid lens.

Preferably, in an embodiment, the optical axis of the at least one first liquid lens is aligned with the optical axis of the second liquid lens.

A further aspect of the present invention relates to a method for machine vision using an optical device according to the present invention, the method comprising the steps of:
Providing the optical device in an operating mode with the optical axis of the at least one first liquid lens extending vertically,
Receiving incoming light from an object and focusing the light onto the image sensor to generate at least one image, and
Automatically extracting information about the object using said at least one image.

### BRIEF DESCRIPTION OF THE DRAWINGS

Further features and advantages of the present inventions as well as embodiments of the present invention shall be described in the following with reference to the Figures, wherein

FIG. 1A shows schematic cross-sectional views of a first or second liquid lens with a vertical optical axis (a) and a horizontal optical axis (b),

FIG. 1B shows a schematic cross-sectional view of a first or second liquid lens comprising a counteracting rigid phase plate to correct gravitation-induced optical errors (a) and a first or second liquid lens comprising also a stiffer membrane in addition to the phase plate (b),

FIG. 1C shows an optical device for horizontal imaging showing gravity-induced optical errors,

FIGS. 2 and 3 show exemplary embodiments of an optical device,

FIG. 4 shows a schematic view of an embodiment of a second optical path of an optical device using a folding element for horizontal imaging,

FIG. 5 shows a schematic view of a further embodiment of an optical device using a rigid objective lens for vertical imaging,

FIG. 6 shows a schematic view of a further embodiment of an optical device using a folding element for horizontal imaging, and

### DETAILED DESCRIPTION

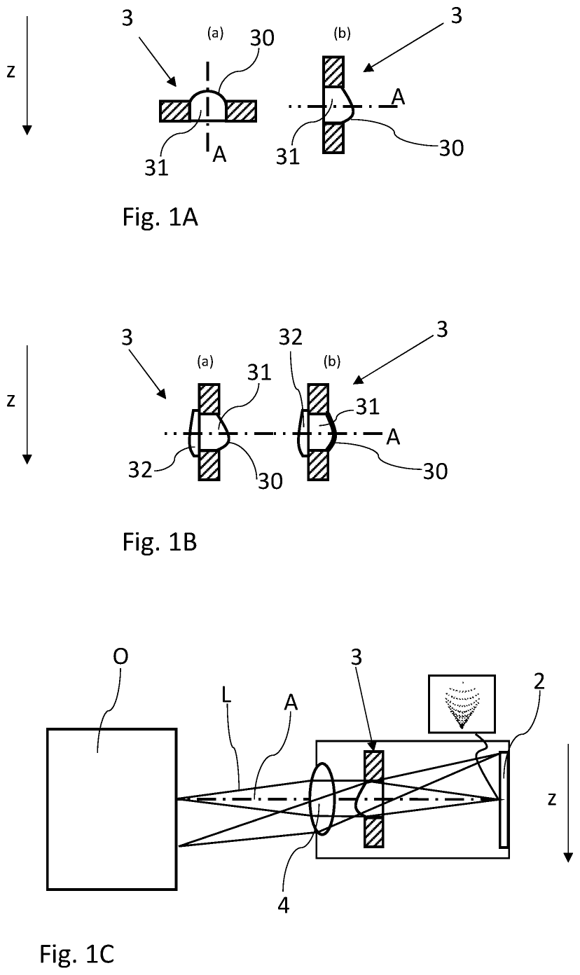

FIG. 1A shows two schematic cross-sectional views of a first liquid lens 3 comprising a transparent deformable membrane 30 adjacent a transparent liquid 31. Altering the curvature of the membrane 30 allows to adjust the focal power of the first liquid lens 3. Suitable techniques for adjusting the curvature of the membrane 30 so as to adjust the focal power of the liquid lens 3 are known in the prior art. In particular, the curvature of the membrane may be adjusted by changing the pressure of the liquid 31.

Particularly, the first liquid lens 3 on the left-hand side (a) of FIG. 1A comprises a vertical optical axis A while the right-hand side (b) of FIG. 1A shows a first liquid lens 3 with a horizontal optical axis A, giving rise to gravity-induced rotationally non-symmetric optical errors as indicated by the asymmetric bulge of the membrane 30 on the right-hand side (b) of FIG. 1A. Here and in the following, the vertical direction is indicated by the vector z, pointing in the direction of gravitational force acting on the exemplary embodiment shown in the figures,

FIG. 1B indicates a method for compensating such gravity-induced rotationally non-symmetric optical errors. As shown on the left-hand side (a) of FIG. 1B a counteracting rigid phase plate 32 can be mounted to the liquid lens 3, e.g. on a side of the liquid lens 3 facing away from a side to which the membrane 30 is mounted. Furthermore, as indicated on the right-hand side (b) of FIG. 1B the stiffness of the membrane 30 can be increased to reduce gravity-induced optical errors. However, increasing the stiffness also increases the required actuation force and potentially the heating of the liquid lens 3 which is not desirable.

When employing a first liquid lens 3 in an optical device 1 according to FIG. 10 with horizontal imaging where the optical axis A of the liquid lens 3 extends horizontally, rotationally non-symmetric optical errors are likely to occur, which can only be minimized with costly or complex methods (see above). The exemplary embodiment shown in FIG. 10 shows a point spread function, which indicates coma aberration at the image plane on the sensor 2.

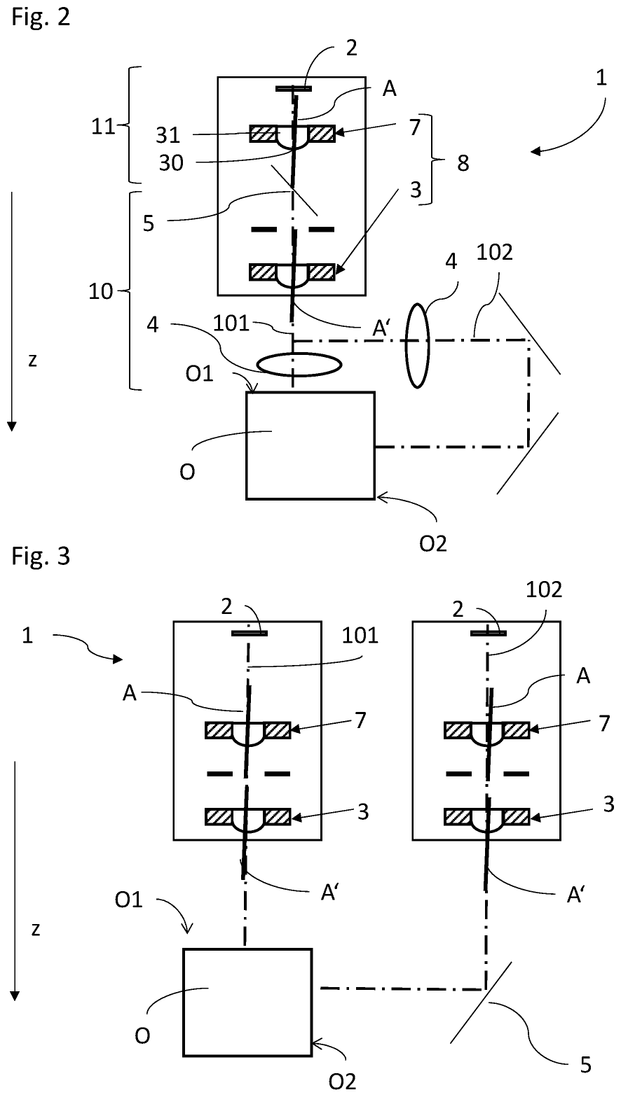

FIG. 2 shows an optical device 1 for machine vision, particularly for automatically extracting information from images of an object O, comprising:
a first optical path 101, which is arranged to image a first object plane O1,
a second optical path 102, which is arranged to image a second object plane O2,
an image sensor 2 which is arranged to capture the image of the first and/or second object plane O1, O2.

The first object plane O1 extends obliquely, in particular perpendicular, with respect to the second object plane O2. The first optical path 101 and the second optical path 102 extend through a first liquid lens 3 with an optical axis A, wherein the optical axis extends A vertically.

The first optical path 101 and the second optical 102 path extend through a common first liquid lens 3, wherein the first liquid lens 3 comprises a deformable transparent membrane 30 and a transparent liquid 31 arranged adjacent the membrane 30, wherein the optical device 1 is configured to adjust the focal power of the first liquid lens 3 by changing a curvature of said membrane 30.

A folding element 5 is arranged in at least one of the first and the second optical path 101, 102, wherein the folding element 5 is arranged to redirect light L coming from the second object plane O2 to the first liquid lens 3. Light L coming from the first object plane O1 is transmitted straight through the folding element 5.

The first 101 and the second optical path 102 extend through a front part 10 and a back part 11 respectively, the front part 10 being configured to receive light L coming from the object O and to pass light to the back part 11. The back part 11 comprises the at least one first liquid lens 3, wherein the front part 10 comprises a rigid objective lens 4 for passing light L to the at least one first liquid lens 3.

The back part 11 of the first 101 and second 102 optical path extends through a second liquid lens 7 arranged between the at least one first liquid lens 3 and the image sensor 2.

The optical device 1 comprises an optical zoom device 8, the optical zoom device 8 comprising at least one first liquid lens 3 and at least one second liquid lens 7.

The second liquid lens 7 comprises an optical axis A′, the optical axis A′ of the second liquid lens 7 extends vertically in the operating mode. The optical axis A of at least one first liquid lens 3 coincides with the optical axis A′ of the second liquid lens 7.

FIG. 3 shows an exemplary embodiment of an optical device 1, wherein the first optical path 101 and the second optical path 102 extend through different first liquid lenses 3. Thus, the first optical path 101 and the second optical path 102 are not superimposed. The first liquid lenses 3 respectively comprises a deformable transparent membrane 30 and a transparent liquid 31 arranged adjacent the membrane 30, wherein the optical device 1 is configured to adjust the focal power of the first liquid lenses 3 by changing a curvature of said membranes 30, and the optical axes A of the first liquid lenses 3 extend parallel to each other.

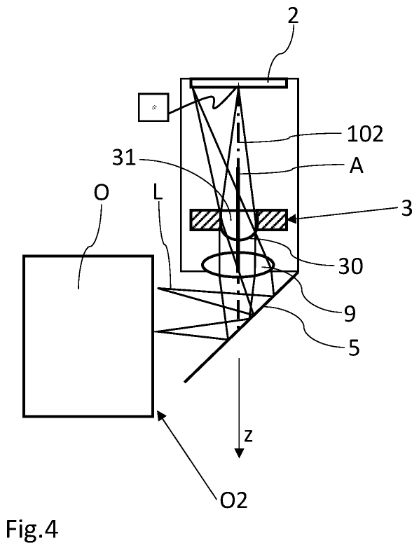

FIG. 4 shows an exemplary embodiment of a second optical path 102 of the optical device 1 for machine vision that is improved regarding the above-identified problem of gravity-induced optical errors. The optical device 1 for machine vision, namely for automatically extracting information from an image of an object O, comprises an image sensor 2, the at least one first liquid lens 3 comprising an optical axis A that preferably always extends vertically, the at least one liquid lens 3 comprising a deformable transparent membrane 30 and a transparent liquid 31 arranged adjacent the membrane 30, wherein the optical device 1 is configured to adjust the focal power of the at least one liquid lens 3 by changing a curvature of said membrane 30, and wherein the optical device 1 is configured to generate an image of the object O by focusing light L coming from the object O on the image sensor 2 using the at least one liquid lens 3.

Particularly, the embodiment of FIG. 4 uses sideways, i.e. horizontal, imaging wherein light L coming from the object O and traveling along the horizontal direction (perpendicular to vector z) is redirected using a folding element 5 (such as a mirror 5 or prism 5) towards the at least one first liquid lens 3. Thus, the second object plane 102 extends along a non-horizontal direction, in particular along a vertical direction, and the optical axis of the at least one first liquid lens 3 extends vertically. The vertical alignment of the optical axis A avoids rotationally non-symmetric optical errors. One or several rigid lenses 9 can be arranged between the folding element 5 and the at least one first liquid lens. 3

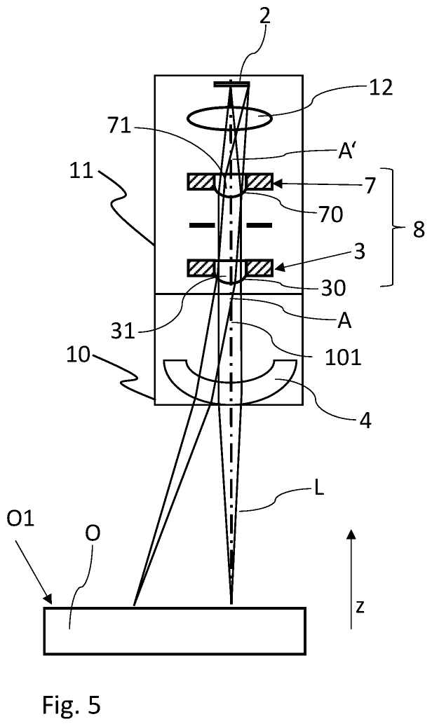

FIG. 5 shows an exemplary embodiment of a first optical path 101 of the optical device 1. The optical device 1 comprises a front part 10 and a back part 11, the front part 10 being configured to receive light L coming from the object O and to pass the light L to the back part 11. The back part 11 comprises the at least one first liquid lens 3. The first optical path 101 is configured perform imaging along the vertical axis z and comprises the first liquid lens 3 and a second liquid lens 7 having congruently aligned optical axes A, A′ which extend parallel to the gravitational vector z. Both, the first and the second liquid lens 3, 7 form components of the back part 11 and each comprise a transparent deformable membrane 30, 70 adjacent a transparent liquid 31, 71 as described above. The first and second liquid lens 3, 7 form an optical zoom device 8. The front part 10 comprises a rigid objective lens 4 as a first optical element along the first optical path 101. The embodiment shown in FIG. 5 is arranged for top-down or bottom-up imaging along the gravitational vector z, wherein the first object plane O1 extends horizontally. Wherein the optical axis A″ of the rigid objective lens 4 is aligned with the optical axes A, A′ of the liquid lenses 3, 7.

Advantageously, for all viewing directions, the liquid lenses 3, 7 always have a vertical optical axis A, A′, respectively, and gravity is not causing any rotationally non-symmetric optical errors. Furthermore, a rigid optical lens 12 (e.g. biconvex) can be arranged between the optical zoom device 8 and the image sensor 2.

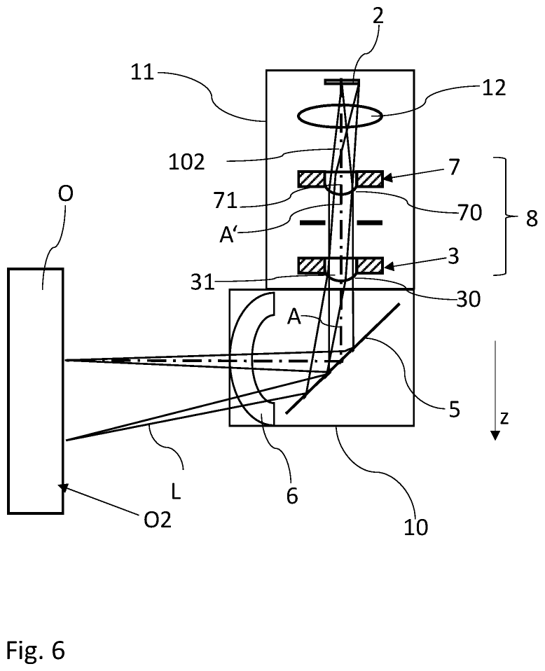

Furthermore, FIG. 6 shows an exemplary embodiment of the second optical path 102 of the optical device 1. The back part 11 is formed according to the embodiment shown in FIG. 5 and the front part 10 is configured for horizontal viewing (cf. also FIG. 4). The front part 10 comprises a folding element 5, here e.g. in form of a mirror 5 (alternatively a prism can also be used). The folding element 5 redirects incoming light L from the second object plane 102 of the object O to the optical zoom 8 formed by the two liquid lenses 3, 7 having coinciding vertical optical axes A, A′, via which optical zoom device 8 light coming from the object via the folding element is focused on the image sensor 2.

Furthermore, the front part 10 optionally comprises a rigid objective lens 6 arranged in front of the folding element 5, wherein said rigid objective lens 6 can form the first element in the second optical path 102 of the optical device 1. The second optical path 102 extends from the front part 10 to the image sensor 2 via the first and second liquid lens 3, 7. In particular, for all viewing directions, the liquid lenses 3, 7 preferably always have a vertical optical axis A, A′ and gravity is not causing any rotationally non-symmetric optical errors.

I claim:

1. An optical device for machine vision, particularly for automatically extracting information from images of an object (O), comprising:
a first optical path, which is arranged to image a first object plane,
a second optical path, which is arranged to image a second object plane,
an image sensor which is arranged to capture the image of the first and/or second object plane, wherein
the first object plane extends obliquely with respect to the second object plane,
the first optical path and the second optical path extend through a first liquid lens with an optical axis (A), wherein
the optical axis extends (A) vertically.

2. Optical device according to claim 1, wherein the first optical path and the second optical path extend through a common first liquid lens, wherein the first liquid lens comprises a deformable transparent membrane and a transparent liquid arranged adjacent the membrane, wherein the optical device is configured to adjust the focal power of the first liquid lens by changing a curvature of said membrane.

3. Optical device according to claim 1, wherein the first optical path and the second optical path extend through different first liquid lenses, wherein the first liquid lenses respectively comprises a deformable transparent membrane and a transparent liquid arranged adjacent the membrane, wherein the optical device is configured to adjust the focal power of the first liquid lenses by changing a curvature of said membranes, and the optical axes (A) of the first liquid lenses extend parallel to each other.

4. Optical device according to claim 1, wherein the optical device is configured to generate an image of an object in an operating mode of the optical device by focusing light coming from the object on the image sensor by means of the first liquid lenses, wherein the optical device is configured such that in said operating mode the optical axes of both liquid lenses extend vertically and the first object plane and the second object plane extend perpendicular with respect to each other.

5. The optical device according to claim 1, wherein a folding element is arranged in at least one of the first and the second optical path, wherein the folding element is arranged to redirect light coming from the object to the first liquid lens.

6. The optical device according to claim 5, wherein the first and the second optical path extend through a front part and a back part respectively, the front part being configured to receive light coming from the object and to pass light to the back part, the back part comprises the at least one first liquid lens, wherein the front part comprises a rigid objective lens for passing light to the at least one first liquid lens.

7. The optical device according to claim 6, wherein the back part of at least one of the first and second optical path extends through a second liquid lens arranged between the at least one first liquid lens and the image sensor.

8. The optical device according to claim 7, wherein the optical device comprises an optical zoom device, the optical zoom device comprising at least one first liquid lens and at least one second liquid lens.

9. The optical device according to claim 7, wherein the second liquid lens comprises an optical axis, the optical axis of the second liquid lens extends vertically in the operating mode.

10. The optical device according to claim 9, wherein the optical axis of at least one first liquid lens coincides with the optical axis of the second liquid lens.

11. A method for machine vision, the method comprising the steps of:
Providing an optical device according to claim 1 such that the optical axis of the at least one first liquid lens extends vertically,
Receiving incoming light from an object and focusing the light onto the image sensor to generate at least one image, and
Automatically extracting an information about the object from said at least one image.
